(19) United States
(12) Patent Application Publication
(10) Pub. No.: US 2010/0064801 A1
(43) Pub. Date: Mar. 18, 2010

(54) METHOD FOR BALANCING SUPERCRITICAL SHAFTS

(76) Inventor: Peter D. Hylton, Brownsburg, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 12/418,255

(22) Filed: Apr. 3, 2009

Related U.S. Application Data
(60) Provisional application No. 61/042,117, filed on Apr. 3, 2008.

(51) Int. Cl. G01M 1/30

(52) U.S. Cl. 73/468

(57) ABSTRACT

Gas turbines are used for power generation with units in a range of sizes. They serve as power plants for both military and commercial aircraft. Demand is for faster, lighter engines, utilizing more advanced manufacturing processes. One of the means of meeting this goal is through use of longer, thinner, more flexible shafts which operate supercritically. Supercritical operation was once viewed as impractical, however, a number of today's production gas turbines operate in this mode. The shaft manufacturing process is optimal if the shaft balance procedure can be conducted at low speeds, rather than requiring a more expensive and complicated high speed balance process. One embodiment of the present invention includes a systematic process for a low speed balance procedure which, would permits a high speed shaft system to transition through additional critical speeds and operate safely above them. Still other embodiments of the present invention pertain to analytical modeling and analysis of representative shaft systems to determine the optimum locations of the balance planes and an approach for predicting shaft responses.

### CROSS REFERENCE TO RELATED APPLICATION

This application claims the benefit of priority to U.S. Provisional Patent Application Ser. No. 61/042,117, filed Apr. 3, 2008, titled METHOD FOR BALANCING SUPERCRITICAL SHAFTS OF JET ENGINES, all of which is incorporated herein by reference.

### FIELD OF THE INVENTION

The present invention pertains to methods for testing the vibratory characteristics of rotating components, and in particular to methods and apparatus for testing and balancing a supercritical shaft.

### BACKGROUND OF THE INVENTION

Gas turbines continue to be an efficient and popular source of power for a variety of industries. They are used for power generation with units ranging from large to microscopically small. They also continue to be the mainstay of propulsion systems for aero-transportation, both military and commercial. Regardless of the application, there continues to be a move toward faster, lighter engines utilizing more advanced manufacturing processes. It has long been recognized that one of the means of achieving these objectives was through the use of long, thin flexible shafts which operate above their first flexible bending mode.

Although supercritical operation was once viewed as impractical, if not impossible, today a number of production gas turbines operate this way, including the T406 (V-22 Osprey military tilt-rotor aircraft), T700 (Apache military helicopter), T800 (Westland Lynx Helicopter), AE2100 (SAAB 2000 commercial aircraft), AE1107 (Military transport aircraft), and the 601K11 (industrial and marine power applications). All these engines are able to pass through, and operate above, their first critical speed, using a combination of rotor balance and system damping.

Traditionally, if a shaft and/or rotor system was to operate near its critical speed, the balancing approach that would be used was a high speed technique, requiring a powerful drive system, significant safety protection, and instrumentation to measure shaft deflection. This required complex and costly equipment specific to each shaft model. The data from multiple trial runs would be used to calculate influence coefficients that could then be used to determine balance corrections for multiple planes.

As gas turbine engine designs began to move to longer, smaller diameter high pressure core compressors, any shafting which went down the center of the core had to gain length and lose diameter, a combination destined to make the shafting more flexible, thus pushing toward supercritical operation. Supporting the use of long, low diameter rotors, a number of researchers have studied ways to balance flexible shafts. This includes a holospectrum approach by Liu and modal balancing and influence coefficient techniques by Tan and Wang.

In order to control costs in production, there was a strong desire to find a way to perform the balance procedure at low speeds, where less expensive equipment and less involved balance procedures are typically used. Various embodiments of the present invention address these needs in novel and unobvious ways.

### SUMMARY OF THE INVENTION

One aspect of the present invention pertains to a method for balancing a shaft. Some embodiments include providing a cylindrical shaft having centerline, a length between first and second ends, and three planes spaced apart from the first end to the second end. Other embodiments include rotating the shaft at a speed less than the critical rotational speed, and measuring at the first end a first unbalance weight acting at a first phase angle, and measuring during said rotating at the second end a second unbalance weight acting at a second phase angle. Yet other embodiments further include applying near the middle of the shaft a first correction weight that is less than the sum of the first unbalance weight and the second unbalance weight and applying the first correction weight at a first corrected phase angle that is between the first phase angle and the second phase angle.

Still further embodiments include applying near a shaft end a second correction weight that is less than the first unbalance weight and applying the second correction weight at a second corrected phase angle that is between the first phase angle and the first corrected phase angle. Yet other embodiments include applying near the other shaft end a third correction weight that is less than the second unbalance weight and applying the third correction weight at a third corrected phase angle that is between the second phase angle and the first corrected phase angle.

Another aspect of the present invention pertains to a method for balancing a shaft. Some embodiments include measuring at the first end of the shaft a first unbalance weight acting at a first phase angle, and measuring at the second end of the shaft a second unbalance weight acting at a second phase angle. Other embodiments further include applying intermediate of the ends a first correction weight that is less than one half of the sum of the first unbalance weight. Still further embodiments include applying near one end a second correction weight that is about one half of the first unbalance weight and applying near the other end a third correction weight that is about one half of the second unbalance weight. Other embodiments further include measuring with the partially balanced shaft a third unbalance weight at the first end, measuring during said rotating the corrected shaft a fourth unbalance weight at the second end, and applying these weights to the respective shaft ends.

Yet other aspects and features of various embodiments of the present invention will be shown in the drawings, specification, and claims to follow.

### BRIEF DESCRIPTION OF THE DRAWINGS

FIG. 1 is a schematic representation of loads along a shaft.

FIG. 2 is a schematic representation of a shaft bending at its first critical speed.

FIG. 3 shows a schematic representation of various distributions of unbalance loads and correction loads.

FIG. 4 shows graphical representations of typical shaft shapes at second and third critical speeds.

FIG. 5 is a graphical representation of ineffective balance loads applied to correct an unbalance at the second critical speed.

FIG. 6 shows graphical representations of a balancing technique according to one embodiment of the present invention for the second and third critical speeds with various unbalance distributions along the length of the shaft.

FIG. 7a shows graphical representations of a balancing technique according to another embodiment of the present invention for the second and third critical speeds and taking into account phasing.

FIG. 7b is a perspective schematic representation of a shaft that is partially balanced according to one embodiment of the present invention.

FIG. 7c is an end view facing the left side of the shaft of FIG. 7b.

FIG. 7d is a perspective schematic representation of the shaft of FIG. 7b after final balancing.

FIG. 7e is an end view of the left end of the shaft of FIG. 7d.

FIG. 8 is a graphical depiction of a mass element model of a shaft segment.

FIG. 9 is a graphical representation of mode shapes for a non-uniform shaft.

FIG. 10 is a graphical representation of displacement field definition for a shaft model.

FIG. 11a shows a schematic representation of a test rig according to one embodiment of the present invention.

FIG. 11b shows a portion of the test rig of FIG. 11a.

FIG. 11c shows a portion of the test rig of FIG. 11a.

FIG. 11d shows a portion of the test rig of FIG. 11a.

FIG. 12 shows an analytical comparison of responses for a uniform shaft with in-phase unbalance distribution under various balance conditions.

FIG. 13 shows an analytical comparison of responses for a uniform shaft with out-of-phase unbalance distribution under various balance conditions.

FIG. 14 shows an analytical comparison of responses for a stepped shaft with in-phase unbalance distribution under various balance conditions.

FIG. 15 shows an analytical comparison of responses for a stepped shaft with out-of-phase unbalance distribution under various balance conditions.

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that must be included in all embodiments, unless otherwise stated.

The use of an N-series prefix for an element number (NXX.XX) refers to an element that is the same as the non-prefixed element (XX.XX), except as shown and described thereafter. As an example, an element 1020.1 would be the same as element 20.1, except for those different features of element 1020.1 shown and described. Further, common elements and common features of related elements are drawn in the same manner in different figures, and/or use the same symbology in different figures. As such, it is not necessary to describe the features of 1020.1 and 20.1 that are the same, since these common features are apparent to a person of ordinary skill in the related field of technology. Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only. Further, discussion pertaining to a specific composition of matter, that description is by example only, does not limit the applicability of other species of that composition, nor does it limit the applicability of other compositions unrelated to the cited composition.

The use of supercritical shafting has proven successful in various production applications. Low speed balance procedures are less expensive than high speed balance procedures and thus more beneficial to production applications. Some embodiments have shown that a shaft operating above one critical speed has been successfully low speed balanced. Other embodiments have demonstrated that the same philosophy can be applied to low speed balancing shafts for operation at higher modes using a set correction scheme to keep production costs low. One embodiment of the present invention has demonstrated that use of higher speed flexible shafting could easily be incorporated to improve future designs of high speed rotating equipment.

One embodiment of the present embodiment pertains to a simplified method for low speed balancing of a shaft that is operated above its first critical speed (i.e., above the first bending mode). In some embodiments, the shaft balancing method accounts for operation of the shaft above the second critical speed (second bending mode) and third critical speed (third bending mode). Because of the non-uniformly distributed stiffness and mass of many shafts, the nodes and antinodes for the lowest bending modes are likewise non-uniformly distributed along the length of the shaft. Predicting the location of these nodes and antinodes (i.e., predicting the mode shape, or the eigenvector) can require complex computer modeling. Further, trying to take these complicated mode shapes into account during balancing operations, especially in a production environment, can be time consuming.

One embodiment of the present invention pertains to a simplified balancing method that provides an adequately balanced supercritical shaft. In one embodiment, the method takes into account out of balance data from a low speed balancing test, and applies that information for application of a plurality of balance weights distributed along the length of the shaft.

In one embodiment, the method includes distributing corrected weights at 5 positions along the length of the shaft. In some embodiments, these positions are equally spaced apart in order to shorten the time required for balancing. In yet other embodiments, weights are applied at 3 points intermediate of the ends of the shaft, and the weights applied at those intermediate points are calculated based on the unbalance loads measured at the ends of the shaft. Although reference has been made to the distribution of weight corrections at five positions, the present invention is not so constrained, and further contemplates those embodiments in which corrections are applied at four positions or more along the length of the shaft.

In yet other embodiments, the phase angles of the measured unbalances at the two ends of the shaft are used to apply weight corrections at calculated phase angles on points distributed along the length of the shaft. As one example, a corrective weight applied proximate the center of the shaft is located at a phase angle that bisects the angle included between the unbalance phase angles measured at the ends of the shaft. In yet other embodiments, the amount of corrective weight applied proximate the midpoint of the shaft is less than half of sum of the unbalance loads measured at the ends.

Yet other embodiments pertain to the application of correction weights at points intermediate of the end of the shaft and the midpoint of the shaft. In one embodiment, the magnitude of the correction is about half or less (and preferably, one-fourth) of the measured unbalance at the shaft end closest to the correction point. In yet another embodiment, the phase angle associated with the aforementioned correction weight is less than half (and preferably, one-fourth) of the included angle between the phase angle at the end proximate to the correction point, and the phase angle measure associated with the measured unbalance at the opposite end of the shaft. As an example, for left and right measured unbalances at 90 degrees and 0 degrees, respectively, the aforementioned correction weight would be within a plane at an angle of about 67.5 degrees (if near the left end), or about 22.5 degrees (if proximate the right end). It is understood that the recitation of such specific angular displacements is for example only, various embodiments of the present invention including a band of variability of at least ±10 degrees.

Another embodiment has shown that basic rotordynamic analysis routines were created and used to examine the viability of the advanced low speed balance scheme. Yet other embodiments have shown that calculations indicate the process is viable.

Other embodiments of the present invention pertain to test rigs useful in the testing, analysis, and production of supercritical shafts of different types. In particular, one embodiment of the present invention pertains to a test rig that accommodates shafts with different types of bearing support, and also the ability to demonstrate and observe different aspects of shaft response. Various test rigs contemplated in different embodiments of the present invention can include one or more of the following capabilities:
1. Ability to observe shaft whip/whirl
2. Ability to demonstrate shaft balances
3. Ability to measure response with various unbalances
4. Ability to experiment with either 2 or 3 bearing shafts
5. Capability to demonstrate shaft misalignment effects
6. Movable bearing supports to accommodate different length shafts or overhung shafts
7. Movable proximity probes to permit measurement of shaft response at different locations

When a long, thin, flexible shaft runs at high speeds, it has a natural tendency to bend, or bow. This tendency is most prominent at the critical speeds of the shaft.

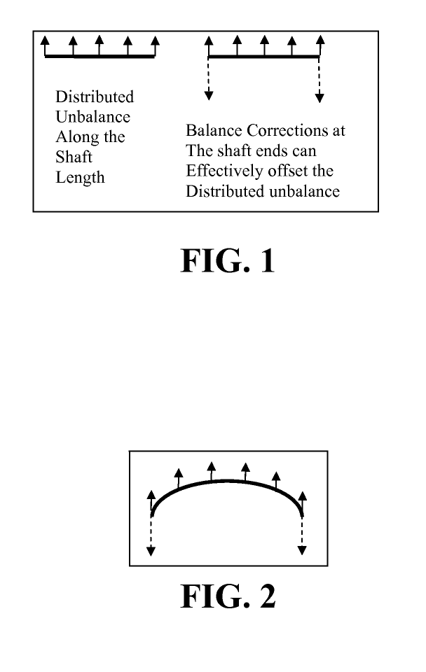

Critical speeds are the speeds at which a shaft's running speed is coincident with its natural frequency, sometimes called its resonant frequency. Thus the rotating unbalance is an excitation of that natural frequency, bringing about large responses. When running at low speeds below the first critical speed, a flexible shaft will behave as a rigid body, and show no signs of bending. Therefore it is possible to effectively balance the shaft by making corrections in any two balance correction planes, which are frequently located at the two ends of the shaft. However, the inherent unbalance of the shaft, as it comes from manufacturing, is likely to be distributed along the length of the shaft. However, so long as the shaft operates at low speeds where it remains rigid, corrections at the two ends will sufficiently balance the shaft. This is shown in FIG. 1.

The fact that a shaft can be balanced at low speed means that standard, readily available balance machines can be used to rotate the shaft and calculate its needed unbalance corrections. These machines may not run any faster than 1000 rpm. However, if the shaft operates above its first critical speed, then it has to pass through a point of significant bending, during which the aforementioned two plane balance correction will be inadequate. This is represented in FIG. 2

In order to balance a shaft that must run at or above its first critical speed, one approach is to add a third correction plane, in the center of the shaft. In order to determine how much of a balance correction to make at each of the three balance planes, the shaft should be rotated fast enough that it begins to assume the modal shape associated with the first critical speed. Trial balance weights are added to the shaft during this high speed running, and from that, appropriate balance corrections can be calculated.

The problem with this procedure is that it a complicated balance machine. The machine should be powerful enough to spin the shaft up to the critical speed, which may be several thousand rpm. Additionally, the balance equipment will have to provide adequate protection for the surroundings, since a shaft spinning at such speeds has a tremendous amount of energy to dissipate if anything goes wrong. Thus a full enclosure may be required, whereas the low speed machine requires much less in the way of protection. Instrumentation adequate to monitor how the shaft is moving and to assure that the shaft is not whirling at unsafe amplitudes is also required. By the time all of these considerations are taken into account, the high speed balance machine is larger and more complicated, as well as much more expensive, than the low speed machine.

In addition, it takes longer to spin the shaft to higher speeds. Time must also be added for securing the shaft and adjusting the instrumentation before runs. So in the end, a high speed balance procedure not only requires more expensive equipment, it requires more time to operate, thus further increasing the cost of the balancing procedure.

For this reason, various embodiments of the present invention pertain to a balancing procedure that not only could be executed at low speed, but which also would permit corrections to be made in a third plane, thus better correcting for operation at the first critical speed. Experience in the gas turbine industry has shown that it is possible to modify the low speed balance procedure using certain assumptions about the shaft. Using a basic assumption for the type of distribution the unbalance takes along the length of the shaft, and that the shape that the shaft will take during operation is a simple sinusoidal (0 to π) distribution, it was possible to derive a low speed balance process wherein the balance machine determines the amount of unbalance that should have been made at the two ends for a standard low speed procedure. By using half of the total value of the calculated corrections at the end planes, and instead applying this amount of correction at the center plane, it was possible to approximate a third balance correction plane. A second run was then made of the quasi-balanced shaft on the balance machine, again using it to calculate corrections at the two end planes. This time the corrections were, in fact, made at those planes, and the shaft is then considered balanced. Repeated use of this procedure has proven successful on a number of shafts for production gas turbines currently in use in the aerospace industry.

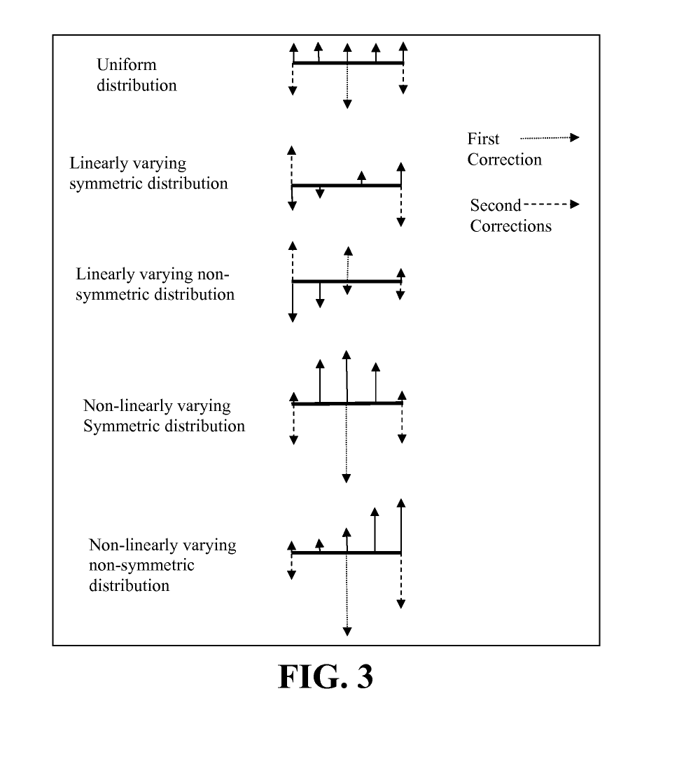

Even if the distribution of unbalance along the shaft is not uniformly distributed as was shown in FIG. 1, this procedure may permit a satisfactory balance to be achieved for other common unbalance distributions that are likely to be found as a result of manufacturing imperfections, as shown in FIG. 3.

These figures do not take into account phase differences of other than zero and 180 degrees. But study will show that for other phase variations, the procedure for calculating a center shaft unbalance correction will, in fact, yield a far better balanced shaft than would a standard two plane low speed balance procedure. And in most cases, it will approach the accuracy of a high speed balance procedure, but at far less cost and time, which is imperative in the production environment. If the unbalance distribution begins to “corkscrew” along the length of the shaft, the procedure start to yield weaker results. But the likelihood of that type of distribution being the result of normal manufacturing processes is small.

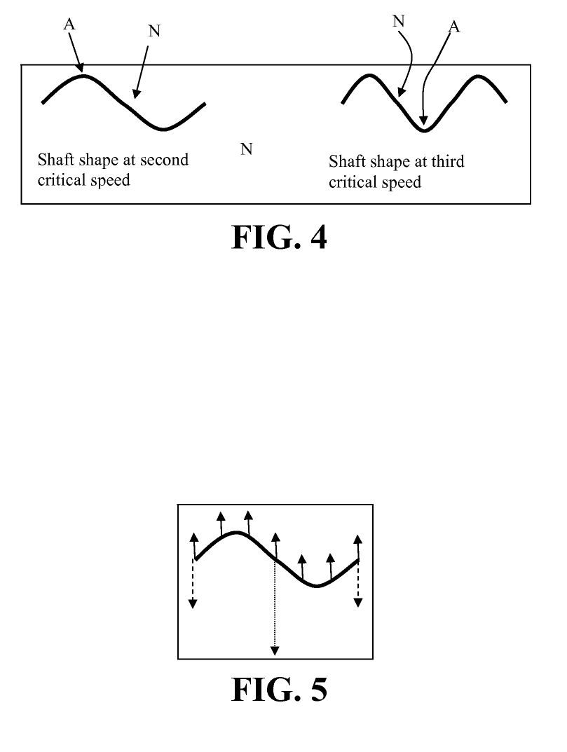

If newer, lighter, faster turbines are to utilize shafts which run above their second or even third critical speed, then a similar unbalance procedure will have to be found to permit low speed balance procedures to be used in the production environment. The approximate shape of the shaft as it goes through its second and third critical speeds is shown in FIG. 4.

Various embodiments of the present invention described herein take into account the mode shape of the shaft. The points on the shaft where there is no motion (e.g. for the second bending mode these are typically the ends and center) which are called nodes N. Points of maximum displacement intermediate of the nodes N are referred to antinodes A Balance corrections made at the nodes are ineffective because the unbalance distributed across the actively moving part of the shaft is what creates the driving force that makes the shaft respond at its critical speed. To be effective, the forces created by the countering balance corrections should offset the forces created by those distributed forces. As can be seen by looking at the modes shapes, corrections made at the nodes do not accomplish this. Therefore, the center correction which was so much help at the first critical speed will not address the second critical speed mode shape, as shown in FIG. 5, because all three balance corrections will be at locations where there is little shaft motion, and the parts of the shaft which have larger motion have no offsetting balance correction.

One might reasonably say that picking two balance correction planes, each one quarter of the way in from the ends of the shaft might be effective. But that would be effective for the second critical speed mode shape. If one considers that in order to get to the second critical speed, the shaft must already have gone through the first critical speed, then clearly the balance locations chosen have to be effective for both shapes. Given that reasoning, corrections ¼, ½, and ¾ of the way along the shaft length make sense. If, however, our objective is to also find a low speed balance procedure that will potentially work for the third critical speed as well, then we need to consider how that would effect the shaft when it is running deflected in that shape. The maximum deflections in that shape are ⅙, 3/6 (i.e. ½), and ⅚ along the length, and these may be the points at which to make corrections. However, the previously suggested corrections at ¼, ½, and ¾ are not hugely different from this. ( 3/12, 6/12, 9/12 versus 2/12, 6/12, 10/12) and are likely to be fairly effective for the third mode shape.

Some embodiments of the present invention pertain to a standardized balance procedure that can be used to low speed balance shafts quickly and efficiently on a production basis without requiring multiple balance trials and individual influence coefficient calculations on each shaft. A balance procedure according to one embodiment of the present invention is as follows:

1. Use a low speed balance process to calculate shaft unbalance corrections at the shaft ends.

2. Add the two calculated unbalances, accounting for phase, and correct for a portion (in one embodiment, ¼) of this value at the center of the shaft, at a phase angle that is the average of those for the two calculated unbalances.

3. Take the calculated correction at the left end of the shaft and apply another portion of that correction (in one embodiment, ¼) of the way along the shaft, and at an angle half way between the calculated end correction and the correction just made at the center.

4. Repeat step 3 for the right end.

5. Re-run the shaft on the balance machine, recalculate the end corrections and apply them as indicated

6. Check shaft for acceptability of final balance

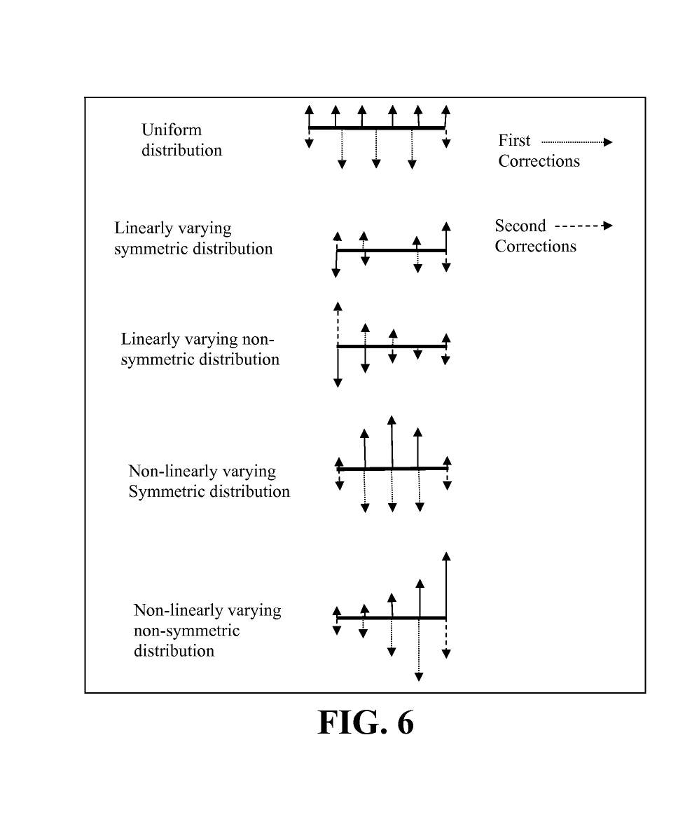

A graphical examination of this balance logic for the different unbalance distributions previously discussed is shown in FIG. 6.

Observation of these graphical results shows that corrections can be made across the length of the shaft that should reasonably correct for the unbalance distributions in a manner that accommodates the first three shaft bending modes.

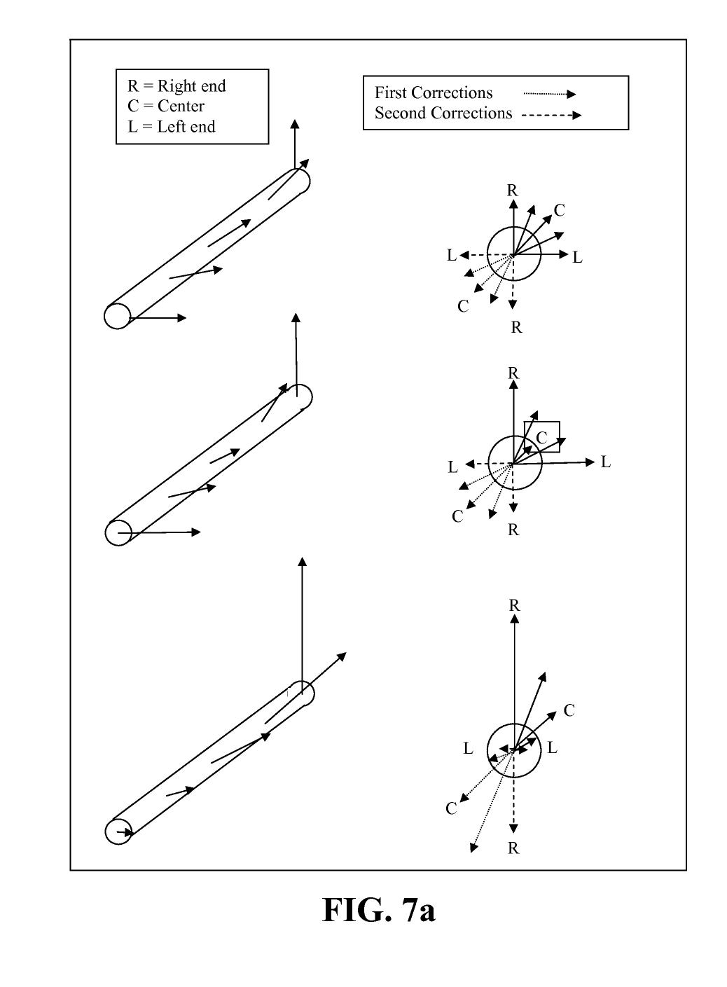

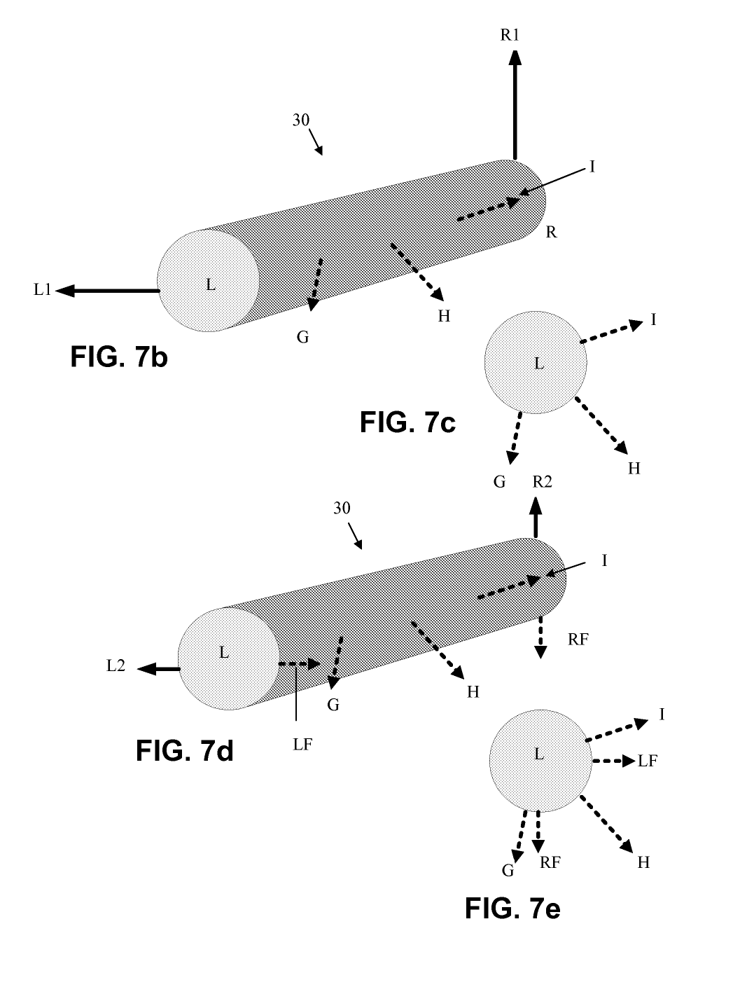

Some embodiments of the present invention include a simplifying assumption that most of the unbalance is distributed in-plane. That is, the unbalance vectors are at either 0° or 180° relative to a fixed angular shaft location. Another embodiment of the present invention considers what the effect would be if the phase distribution varied as shown in FIGS. 7a, 7b, 7c, 7d, and 7e.

In the cases shown, the phase relationship between the ends varies through ninety degrees rather than being fixed at 0° or 180°. In all cases the resulting final state of balance is not as good as it would have been in the previous cases where the unbalance distribution was all in the same plane. However, the final state of balance is better than it would have been if the shaft had gone through a simple two plane balance process. The process can be effective for an out-of-balance distribution that is generally all in one plane. The effectiveness decreases as the unbalance vectors rotate in angularity as you move along the shaft. This would correspond to a shaft in which the bore corkscrews relative to the outer diameter surface.

Typical manufacturing errors are more likely to produce a shaft where the outer diameter (OD) and inner diameter (ID) centerlines are either offset or skewed rather than the “corkscrew” distribution just described.

If in step 5 of the balance process, the predicted corrections are not appreciably less than they were in step 1, then there is a likelihood that the shaft has a more complex unbalance distribution. The likelihood of this occurrence will be reduced if tight tolerances are held for centerline offset and wall thickness and if inspection is done on these dimensions before a shaft is accepted and sent to balance. The balance procedure described and demonstrated should be able to greatly improve the ability of a shaft to operate at higher critical speeds as effectively as existing supercritical shafts currently operate at the first critical speed.

However, one aspect thus far has been that the shaft is of uniform diameter and wall thickness (i.e. constant cross section along its length). If the shaft cross section varies, then the mode shapes will not match the “typical” shapes which were used to form our earlier assumptions. The node points and points of maximum deflection will not be in the same locations as we have assumed. This means that choosing the locations of the correction planes is more complicated. In order to pick the optimum location, a more accurate prediction of the mode shapes at the critical speeds is possible.

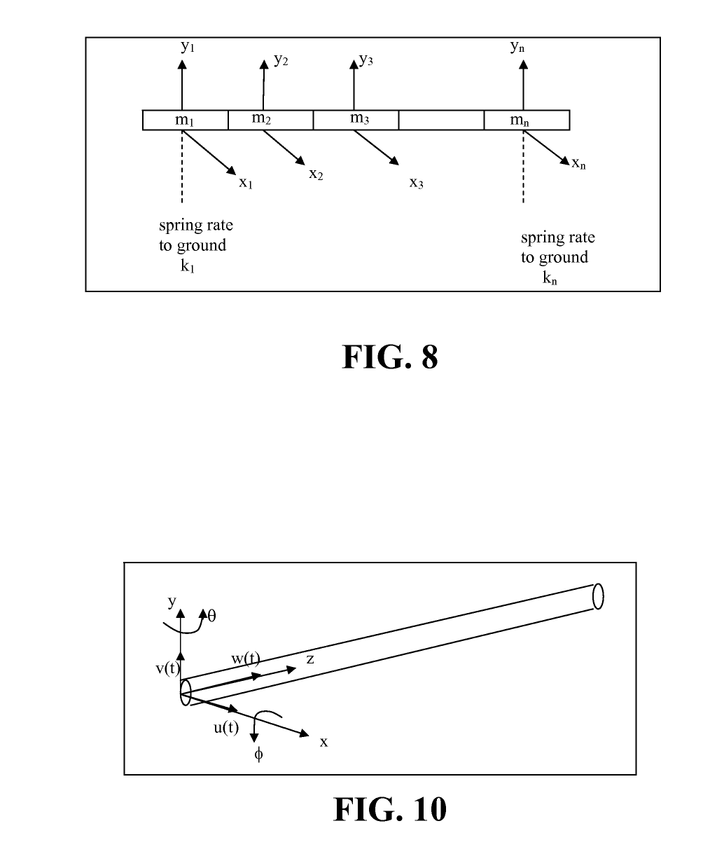

A model of the shaft as a series of elements, 1 through n is shown in FIG. 8. Each element has a mass, assumed to be located at the center of the element, and a stiffness, which can be estimated fairly accurately from beam element theory. This stiffness calculation is a fairly common approach using Euler or Timoshenko beam theory.

The dynamic equation for the shaft shown in FIG. 8 can now be written in the matrix form

[M](X″)+[K](X)=(0)

Where (X) is the vector of all displacements:

$$( X ) = \vert \begin{matrix}{x}_{0} \\ {x}_{1} \\ ⋮ \\ ⋮ \\ {x}_{n}\end{matrix} \vert$$

and (X″) is the acceleration vector of those same displacements, that is the second derivative of the displacements with respect to time

$$( {X}^{″} ) = \vert \begin{matrix}{d}^{2} {x}_{0} / d {t}^{2} \\ {d}^{2} {x}_{1} / d {t}^{2} \\ ⋮ \\ ⋮ \\ {d}^{2} {x}_{n} / d {t}^{2}\end{matrix} \vert$$

[M] is the mass matrix, containing all of the individual elemental masses, determined from the volume of each element times the mass density of the material comprising that element.

$$[ M ] = \vert \begin{matrix}{m}_{1} & 0 & 0 & … & 0 \\ 0 & {m}_{2} & 0 & … & 0 \\ ⋮ & & & & ⋮ \\ ⋮ & & & & ⋮ \\ 0 & 0 & 0 & … & {m}_{n}\end{matrix} \vert$$

[K] is the stiffness matrix, containing the stiffness effects of all the individual elemental stiffnesses.

$$[ K ] = \vert \begin{matrix}( {k}_{1} + {k}_{1 , 2} ) & - {k}_{1 , 2} & 0 & 0 & … & 0 \\ - {k}_{1 , 2} & ( {k}_{1 , 2} + {k}_{2 , 3} ) & - {k}_{2 , 3} & 0 & … & 0 \\ 0 & - {k}_{2 , 3} & ( {k}_{2 , 3} + {k}_{3 , 4} ) & - {k}_{3 , 4} & … & 0 \\ ⋮ & & & & & ⋮ \\ ⋮ & & & & & ⋮ \\ 0 & 0 & 0 & 0 … & - {k}_{n - l , n} & ( {k}_{n - 1 , n} + {k}_{n} )\end{matrix} \vert$$

These make up the terms of the system matrix equation

[M]{X″}+[K]{X}={0}

We expect to have harmonic oscillations for a vibrating system. If we therefore assume a harmonic solution of the form x=e^{iωx} then x′=iω e^{iωx} and x″=(iω)²e^{iωx}=−ω² e^{iωx}, letting λ=ω² and substituting into the matrix equation, we get

−λ[M]{X}+[K]{X}={0}

### Rearranging,

[K]{X}−λ[M]{X}={0}

Multiply all terms by [M]⁻¹

[M]⁻¹[K]{X}−λ[M]⁻¹[M]{X}={0}

Letting [A]=[M]⁻¹[K], we have [A]{X}−λ[I]{X}={0} or [[A]−λ[I]]{X}={0}

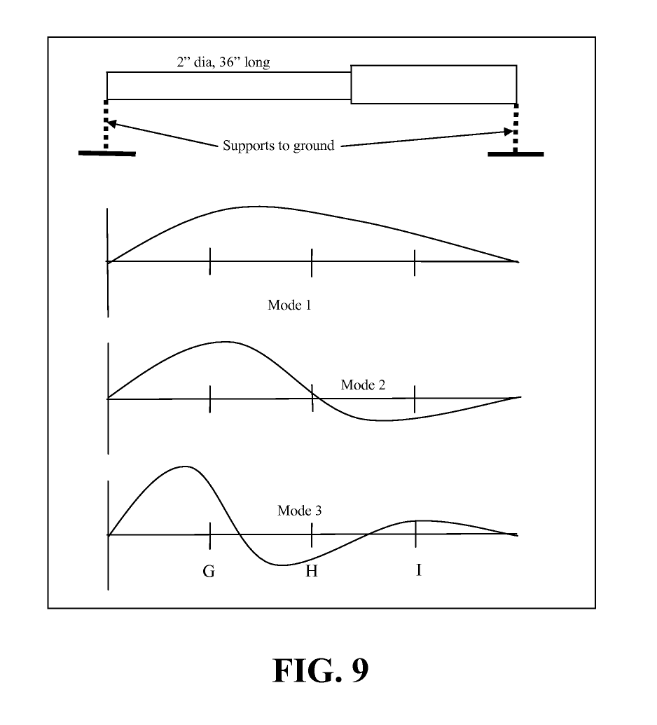

This is the standard expression for an eigenvalue problem. The eigenvectors that would result from this equation would correspond to the mode shapes that we want to use for our shape functions with certain embodiments of the present invention. Each of the normalized eigenvectors resulting from the above process will yield pairs of points which correspond to a mode shape of the model created in FIG. 8. A curve plotted through these points would define the shape function for the mode. We can define the shape function as a continuous function of z, the distance along the shaft. What we have are normalized vectors {X}, where each term, xₙ, of the vector relates to the normalized displacement of each local coordinate xₙ that defines the motion at the individual mass elements mₙ of the model at locations zₙ along the length of the shaft. In order to create a continuous shape function for each of these, we fit a polynomial to the pairs of points. The resulting mode shapes for a non-uniform shaft, as determined using this technique are shown in FIG. 9.

FIG. 9 further shows correction locations G, H, and I according to one embodiment of the present invention. These three locations, G, H, and I are preferably uniformly distributed and equally separated between the first and the second ends of the shaft. As can be seen in FIG. 9, these three correction points (also correction planes) do not necessarily coincide with nodes or antinodes of the three bending mode shapes shown in FIG. 9. Yet other embodiments of the present invention pertain to balancing methods that include at least four corrections along the length of the shaft, such as corrections at each end and also two correction points (or planes) intermediate of the two ends, and preferably equally spaced apart.

Since the deflection points that we have from the mode shapes will not necessarily be equally spaced, Newton's interpolation approach or other interpolation approaches can also be used to create a smooth shape. A difference table is created using the paired points of (zₙ, xₙ) where zₙ are the locations along the shaft where the mₙ masses were located, and the xₙ terms are the corresponding individual normalized deflections for any given mode shape vector {Xₙ} which we previously found.

| zₙ | xₙ | |
|---|---|---|
| z₁ | f(z₁) = x₁ | |
| | f(z₁, z₂) = (x₂ − x₁)/(z₂ − z₁) | |
| z₂ | f(z₂) = x₂ | f(z₁, z₂, z₃) = f(z₂, z₃) − f(z₁, z₂)/(z₃ − z₁) |

| | |
|---|---|
| f(z₂, z₃) = (x₃ − x₂)/(z₃ − z₂) | f(z₁, z₂, z₃, z₄) = f(z₂, z₃, z₄) − f(z₁, z₂, z₃)/(z₄ − z₁) |

| | | |
|---|---|---|
| z₃ | f(z₃) = x₃ | f(z₂, z₃, z₄) = f(z₃, z₄) − f(z₂, z₃)/(z₄ − z₂) |

| | f(z₃, z₄) = (x₄ − x₃)/(z₄ − z₃) |
|---|---|
| z₄ | f(z₄) = x₄ |

The polynomial that describes the n^{th} shape function is now

βₙ=f(z₁)+f(z₁,z₂)(z−z₁)+f(z₁,z₂,z₃)(z−z₁)(z−z₂)+f(z₁,z₂,z₃,z₄)(z−z₁)(z−z₂)(z−z₃)

This can be done to create a polynomial βₙ for eigenvector/mode shapes {Xₙ}. To find the nodes we can determine the zeros of this polynomial. The maximums of the curve can be approximations for the maximum deflection points in the mode shapes, and could thus be used to choose the unbalance correction planes rather than the ¼, ½, ¾ points from the last section. In this way, the unbalanced corrections can be tailored to a shaft of varying cross section.

The same method for determining balance correction amounts, used in the previous discussion, would be used, however the locations would be changed based on this analysis. Numerous routines are readily available for creating and analyzing finite element models of structures. However, there are a limited number of programs capable of performing analyses on a rotating shaft system. Another embodiment of the present invention contemplates a math model representation of a shaft using beam element properties and then determining the natural frequencies of the shaft from the system eigenvalues using numerical methods techniques. The system mode shapes have already been determined from the associated eigenvectors. These mode shapes will be used as shape functions in a forced response analysis to predict shaft behavior at speed.

Consider a simplified shaft with displacement fields as indicated in FIG. 10. The x, y, z axis system indicates an inertial coordinate system, fixed in space and located at one end of the shaft when it is at rest. The u, v, w coordinates, which relate to the x, y, z, directions, describe the displacement of the shaft from the at rest position. Angular displacements about the u and v axes are given by φ and θ respectively.

The displacement field u(z, t) is a function of both axial location along the element, z, and time, t which can be written as an expansion of shape functions, derived from the mode shapes, β₁, β₂, . . . βₙ and participation factors, η₁, η₂, . . . ηₙ. The shape functions are functions of the location along the shaft, while the participation factors are functions of time. The participation factors are sometimes also called generalized coordinates.

u(z,t)=Σⁿᵢ₌₁βᵢ(z)ηᵤᵢ(t)

v(z,t)=Σⁿᵢ₌₁βᵢ(z)ηᵥᵢ(t)

These can be written as the product of two vectors

$$u ( z , t ) = {\vert \begin{matrix}{β}_{1} ( z ) \\ {β}_{2} ( z ) \\ {β}_{3} ( z ) \\ ⋮ \\ {β}_{n} ( z )\end{matrix} \vert}^{T} \vert \begin{matrix}{η}_{u 1} ( t ) \\ {η}_{u 2} ( t ) \\ {η}_{u 3} ( t ) \\ ⋮ \\ {η}_{un} ( t )\end{matrix} \vert$$

$$v ( z , t ) = {\vert \begin{matrix}{β}_{1} ( z ) \\ {β}_{2} ( z ) \\ {β}_{3} ( z ) \\ ⋮ \\ {β}_{n} ( z )\end{matrix} \vert}^{T} \vert \begin{matrix}{η}_{v 1} ( t ) \\ {η}_{v 2} ( t ) \\ {η}_{v 3} ( t ) \\ ⋮ \\ {η}_{vn} ( t )\end{matrix} \vert$$

In a simpler form:

u(z,t)=[β(z)]^{T}[ηᵤ(t)]

v(z,t)=[β(z)]^{T}[ηᵥ(t)]

This can be combined into a single equation

$$\vert \begin{matrix}u ( z , t ) \\ v ( z , t )\end{matrix} \vert = \vert \begin{matrix}[ β ( z ) ] & 0 \\ 0 & [ β ( z ) ]\end{matrix} \vert \vert \begin{matrix}[ {η}_{u} ( t ) ] \\ [ {η}_{v} ( t ) ]\end{matrix} \vert$$

Using Euler beam theory, the angular displacements can be written as

$$φ ( z , t ) = {\frac{d}{d t} [ β ( z ) ]}^{T} [ {η}_{v} ( t ) ]$$

$$θ ( z , t ) = {\frac{d}{d t} [ β ( z ) ]}^{T} [ {η}_{u} ( t ) ]$$

Combining these to form a single matrix expression

$$\vert \begin{matrix}u ( z , t ) \\ v ( z , t ) \\ φ ( z , t ) \\ θ ( z , t )\end{matrix} \vert = \vert \begin{matrix}[ β ( z ) ] & 0 \\ 0 & [ β ( z ) ] \\ 0 & [ {β}^{′} ( z ) ] \\ [ {β}^{′} ( z ) ] & 0\end{matrix} \vert \vert \begin{matrix}[ {η}_{u} ( t ) ] \\ [ {η}_{v} ( t ) ]\end{matrix} \vert$$

In a simpler form:

{X(z)}=[C(z)]{η(t)}

The matrix [C(z)] is referred to as the transformation matrix. When [C(z)] is evaluated at any point, z, by plugging the value of z into all the shape functions that make up what we now have designated as [C(z)], it can then be used to relate the generalized coordinates, {η(t)} to the discrete coordinates, {X(z)}.

The inertia matrix associated with the shaft can be derived from the kinetic energy relationships as follows:

T=½ Integral ₀^{L}m(u′)²dz+½₀^{L}m(v′)²dz

Replacing the velocities with their expansions in the generalized coordinates

$$T = \frac{1}{2} {{{Integral}_{0}^{L} [ {η}_{u}^{′} ]}^{T} [ C ( z ) ]}^{T} \vert \begin{matrix}m & 0 & 0 & 0 \\ 0 & m & 0 & 0 \\ 0 & 0 & I & 0 \\ 0 & 0 & 0 & I\end{matrix} \vert \vert [ C ( z ) ] [ {η}_{u}^{′} ] d z$$

The shaft inertia matrix, [Mₛ] is defined as

[Mₛ]=Integral ₀^{L}[C(z)]^{T}[M][C(z)]dz

Such that

T=½[η″]^{T}[Mₛ][η′]

The shaft stiffness matrix can be derived using a technique similar to that for the inertia matrix but starting with the potential energy relationship.

V=½ Integral ₀^{L}EI(u″)²dz+½₀^{L}EI(v″)²dz

Replacing the displacement derivatives with their expansions in the generalized coordinates

$$V = \frac{1}{2} {{{Integral}_{0}^{L} [ η ]}^{T} [ {C ( z )}^{″} ]}^{T} \vert \begin{matrix}EI & 0 & 0 & 0 \\ 0 & EI & 0 & 0 \\ 0 & 0 & 0 & 0 \\ 0 & 0 & 0 & 0\end{matrix} \vert [ {C ( z )}^{″} ] [ η ] d z$$

The shaft stiffness matrix is defined as

[Kₛ]=Integral ₀^{L}[C(z)″]^{T}[I][C(z)″]dz

Such that

V=½[η]^{T}[Kₛ][η]

The equation of motion of the shaft can now be written as

[Mₛ]{η″}+[Kₛ]{η}={N}

Where {N} is the generalized force vector which is a combination of all the individual forces and moments applied to the shaft. Those generalized forces which are linear and shaft motion dependent can be moved to the left side of the equation and included with the inertia and stiffness matrices. For a given discrete force vector {F}, the generalized force vector {N} is

{N}=[C(z)]^{T}{F}

The shaft will experience a force vector due to the inertial and gyroscopic forces on any disk which might be located along the shaft. The expression for these forces is

$$\vert \begin{matrix}{F}_{x} \\ {F}_{y} \\ {M}_{x} \\ {M}_{y}\end{matrix} \vert = - \vert \begin{matrix}M & 0 & 0 & 0 \\ 0 & M & 0 & 0 \\ 0 & 0 & {J}_{D} & 0 \\ 0 & 0 & 0 & {J}_{D}\end{matrix} \vert \vert \begin{matrix}{x}^{″} \\ {y}^{″} \\ {φ}^{″} \\ {θ}^{″}\end{matrix} \vert + \vert \begin{matrix}M {Ω}^{2} & 0 & 0 & 0 \\ 0 & M {Ω}^{2} & 0 & 0 \\ 0 & 0 & 0 & 0 \\ 0 & 0 & 0 & 0\end{matrix} \vert \vert \begin{matrix}x \\ y \\ φ \\ θ\end{matrix} \vert - \vert \begin{matrix}0 & - 2 M Ω & 0 & 0 \\ - 2 M Ω & 0 & 0 & 0 \\ 0 & 0 & 0 & ( {J}_{P} - {J}_{D} ) Ω \\ 0 & 0 & - ( {J}_{P} - {J}_{D} ) Ω & 0\end{matrix} \vert \vert \begin{matrix}{x}^{′} \\ {y}^{′} \\ {φ}^{′} \\ {θ}^{′}\end{matrix} \vert$$

Where M is the disk mass, Ω is the rotational shaft speed, and J_{D} and J_{P} are the mass moment of inertia and the polar moment of inertia, respectively. Converting to generalized forces using [C(z)] and writing this in an abbreviated form we would have

{N_{G}}=−[M_{D}]{η″}−[G]{η′}−[R]{η}

Similarly the force vector due to weight, where g is the gravitational acceleration, is

$$\{ W \} = \vert \begin{matrix}0 \\ - Mg \\ 0 \\ 0\end{matrix} \vert$$

Which, when converted to a generalized force vector is

{N_{W}}=[C(z)]^{T}{W}

The generalized force expressions {N_{W}} and {N_{G}} can now be moved to the left hand side leaving only the nonlinear or time dependent forces, {N(t)} on the right side of the equation. Performing this reorganization, and combining terms, we get

|[M_{S}]+[M_{D}]|{η″}+[G]{η′}+|[K_{S}]+[R]|{η}−{N_{W}}={N(t)}

Simplifying this expression by renaming [R]=[M_{S}]+[M_{D}], [S]=[G],:

[T]=[K_{S}]+[R], so that

[R]{η″}+[S]{η′}+[T]{η}−{N_{W}}={N(t)}

Recognizing that {N(t)} is actually a function of η since η is a function of time, we could calculate {N} for any {η}

$$\{ {η}^{′} \} = \frac{\{ {η}_{n} \} - \{ {η}_{n - 1} \}}{t}$$

$$And$$

$$\begin{matrix}\{ {η}^{″} \} = \frac{\{ {η}_{n}^{′} \} - \{ {η}_{n - 1}^{′} \}}{t} \\ = \frac{\{ {η}_{n} \} - \{ {η}_{n - 1} \}}{{t}^{2}} - \frac{\{ {η}_{n - 1} \} - \{ {η}_{n - 2} \}}{{t}^{2}} \\ = \frac{\{ {η}_{n} \} - 2 \{ {η}_{n - 1} \} + \{ {η}_{n - 2} \}}{{t}^{2}}\end{matrix}$$

Substituting and rearranging,

t⁻²[R]{ηₙ}+t⁻¹[S]{ηₙ}+[T]{ηₙ}−{N_{W}}=2t⁻²[R]{ηₙ₋₁}−t⁻²[R]{ηₙ₋₂}+t⁻¹[S]{ηₙ₋₁}+{N(ηₙ₋₁)}

We can create a recurrence relationship

{ηₙ}=|t⁻²[R]+t⁻¹[S]+[T]|⁻¹|[2t⁻²[R]{ηₙ₋₁}−t⁻²[R]{ηₙ₋₂}+t⁻¹[S]{ηₙ₋₁}+{N(ηₙ₋₁)}+{N_{W}}|

Which will allow us to solve for {η} iteratively given an initial assumption of {η₀}. We simply apply the algorithm successively until the value of {ηₙ} converges within an acceptable error bound.

An additional capability of this model is to permit the inclusion of disks into the model, which could represent turbine wheels or gears. The gyroscopic effects of these disks is included which is a feature not critical to some dynamic analyses. However, when dealing with high speed rotating shafts, it is, in fact, desirable that this be included.

Any program which accurately represents the mass, stiffness, and gyroscopic effects of the rotating shafting and the support stiffness can be utilized in such an analysis. Using such a program, the previously described low speed balance approach has been applied to some of the unbalance distributions which were shown in FIG. 6 and FIG. 7a.

FIGS. 7b, 7c, 7d, and 7e are schematic representations of a balancing procedure according to one embodiment of the present invention. FIG. 7b shows a shaft 30 having a measured unbalance vector L1 at left end L, and a measured unbalance vector R1 at the right end.

During the balancing operation, measurements L1 and R1 are made at each end of the shaft that correspond to the out-of-balance state of the shaft. As one example, a measure out-of-balance could be one gram-centimeter, displaced 25 degrees from a reference plane. Such a measured unbalance can be corrected with either of two different calculated corrections. As one example, a first calculated correction could be by adding one gm-cm at an angle 180 degrees opposite of the unbalance (i.e., at 205 degrees). A second, equivalent correction would be to remove one gm-cm at 25 degrees. The calculated corrections referred to herein can be either by adding material, removing material, or a combination of both. For the corrections G, H, and I shown in FIGS. 7b, 7c, 7d, and 7e, the corrections are shown as additions of weight.

Based on these two measurements L1 and R1, the corresponding left L and right R corrections L1C and R1C are calculated. A mid-shaft correction H is applied at a point approximately midway between the right and left ends, and in some embodiments halfway between the right and left ends. The value of H (magnitude) is less than one-half of the sum of L1C and R1C. In some embodiments, the correction H has a magnitude that is preferably one-fourth the sum of L1C and R1C.

As can best be seen in FIG. 7c, the direction (phase) of correction H is midway between the phase angles of measurements L1 and R1, and further in a direction to vectorially reduce the vector sum of L1 and R1. In one embodiment, correction H is applied at a phase angle that is one-half of the average value of the phase for the calculated corrections. Referring to FIG. 7c, if unbalance R1 is considered to be at a phase of 0 degrees, and unbalance L1 is considered to be at a phase angle of +90 degrees, then correction H is preferably applied as an addition of weight at a phase angle of 225 degrees.

Referring to FIG. 7b, a correction G is applied to shaft 30 at a location midway between left end L and correction H. In some embodiments, correction G is located half way from end L to correction H. Correction G has a magnitude that is about one-half of the magnitude of L1C. Correction G is applied at a phase angle that is midway between L and H. Preferably, the phase angle of G is half way between the phase angle of L and the phase angle of H. Referring to the example given above in which L1 has a phase angle of 90 and H has a phase angle of 225, correction G would have a phase angle from about 155 degrees to about 160 degrees, and most preferably at 157.5 degrees.

A correction I is applied to shaft 30 in a manner analogous to the correction G previously discussed. The magnitude of I is less than half of the calculated correction R1C, and is placed at a phase angle that is midway between the phase angle of calculation R1C and correction H.

After the corrections G, H, and I have been made to shaft 30, other embodiments of the present invention include a second balancing test performed on the partially corrected shaft. As best seen in FIG. 7d, the second balancing test indicates additional corrections L2C and R2C, as measured at the left and right end. These calculated unbalances are applied to the respective ends of the shafts, and at a phase angle that is 180 degrees opposite of the calculated phase angle. Referring to FIG. 7e, a final correction LF is applied at the left end, with a magnitude substantially the same as calculation L2C, and at a phase angle that is about opposite the phase angle of the calculated number (for the example, LF is at a phase angle of 270 degrees). Similarly, the final correction RF is applied at the right end of the shaft, the correction RF being substantially equal in magnitude to the calculation R2C, and at a phase angle that is substantially opposite the phase angle of R2C (in terms of the example given above, RF is at a phase angle of about 180 degrees).

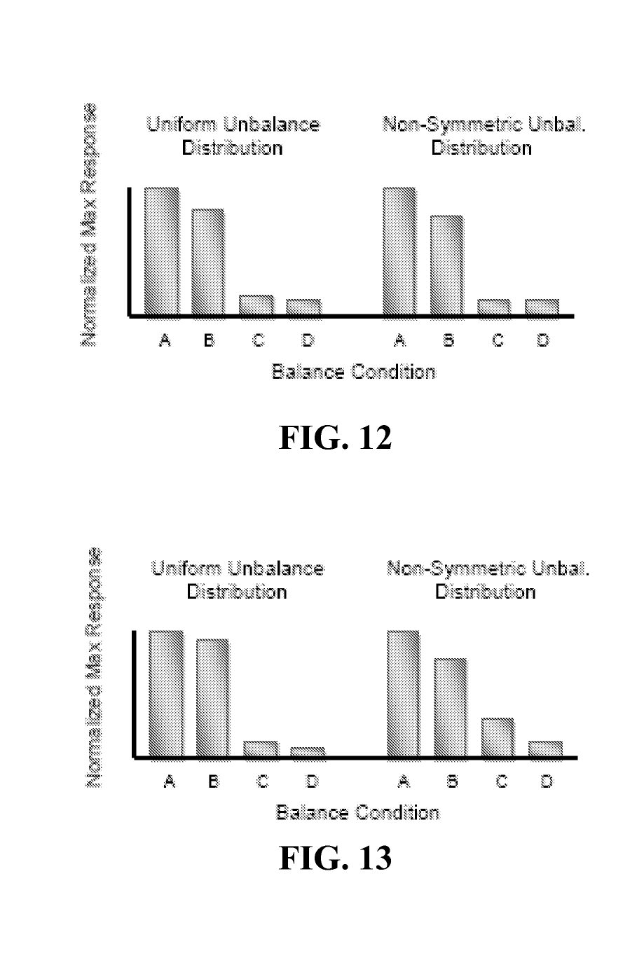

Referring to FIGS. 12, 13, 14, and 15, a uniform unbalance distribution and a non-symmetric unbalance distribution were examined. Data from four balance conditions were used. Condition A is the unbalanced state. Condition B simulates the effect of performing a traditional, two plane, low speed balance. The low speed balance procedure according to one embodiment of the present invention discussed in this paper is shown in condition C. Condition D is an attempt to simulate the effects of performing a high speed balance procedure on the shaft. Analysis results were produced up through the third critical speed or bending mode of the shaft. The results were normalized against the greatest response (which is, as should be expected, the uncorrected unbalance of condition A). The comparisons shown in FIG. 12 represent the predicted responses of a constant diameter shaft which began with an unbalance distribution which was entirely in-phase, similar to what was previously shown in FIG. 6. The comparisons shown in FIG. 13 represent the predicted responses of the same shaft, but with an initial unbalance distribution which varied in phase, similar to what was shown in FIG. 7.

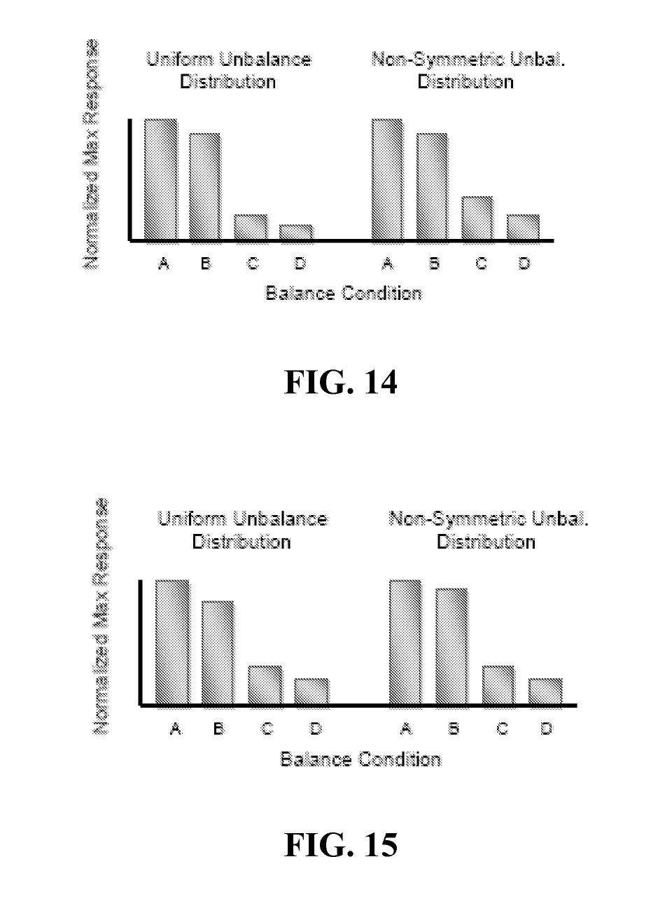

unbalanceunbalanceunbalanceunbalanceunbalanceunbalanceunbalanceA non-uniform, stepped shaft, as discussed earlier and shown in FIG. 9, is contemplated in some embodiments of the present invention. The same sets of initial unbalance states and balanced conditions were run on this shaft. However, the balance procedure associated with condition C was modified as discussed in the previous section of this report to account for the change in mode shape associated with a shaft that had two different diameter segments. The comparisons shown in FIG. 14 represent the predicted responses for an unbalance distribution which was entirely in-phase. The comparisons shown in FIG. 15 represent the predicted responses of the same shaft, but with an initial unbalance distribution which varied in phase.

Gas turbine standards generally do not specify an absolute amount of shaft unbalance which is acceptable or a set amount of center of gravity offset which may be allowed. Rather, they specify a response level that is acceptable. This approach is taken because there are several ways that unbalance can be accommodated in high speed rotating machinery. In addition to balance correction, unbalance response can be reduced by the design of support structures which incorporate flexibility and damping, by mechanical isolation systems which control the spring rate supporting rotating components while simultaneously adding damping to the system, or by hydrodynamic forces and damping which can be introduced via hydrodynamic journal bearings or by squeeze film dampers in conjunction with rolling element bearings. For example, API 616 specifies that high speed balancing is acceptable if necessary to meet response requirements, but it is not desirable, indicating that low speed balance is definitely preferable. The data produced here indicates that for shafts operating up through their third critical speed, or flexible mode, a low speed procedure according to one embodiment of the present invention could substitute for a high speed procedure.

No matter how much effort is applied, no shaft will ever be perfectly balanced. Vibration theory says that at a shaft resonance (i.e. operation exactly at a critical speed) the system response will become unbounded (i.e. infinite) if there is no system damping. While there will always be some material damping, it is typical that a supercritical shafting design include additional damping as provided by hydrodynamic bearings or squeeze film dampers on rolling element bearings. This model also permits inclusion of the damping at the bearings.

Using these calculations, the previously discussed unbalance distributions can be analytically evaluated against the proposed balance correction technique. The results should indicate a reasonably good chance of success could be achieved by low speed balancing with this technique.

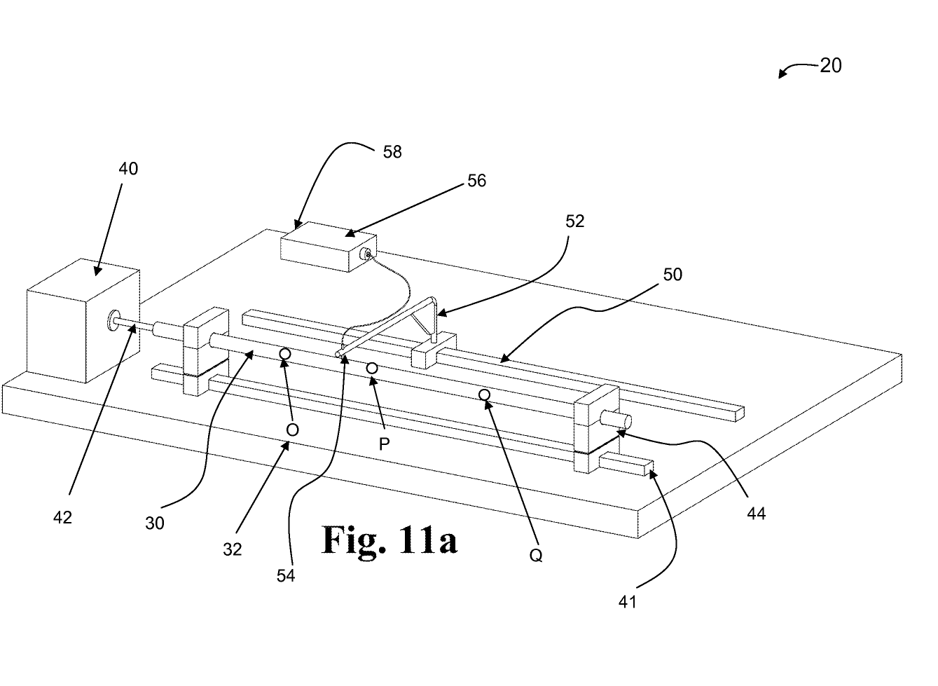

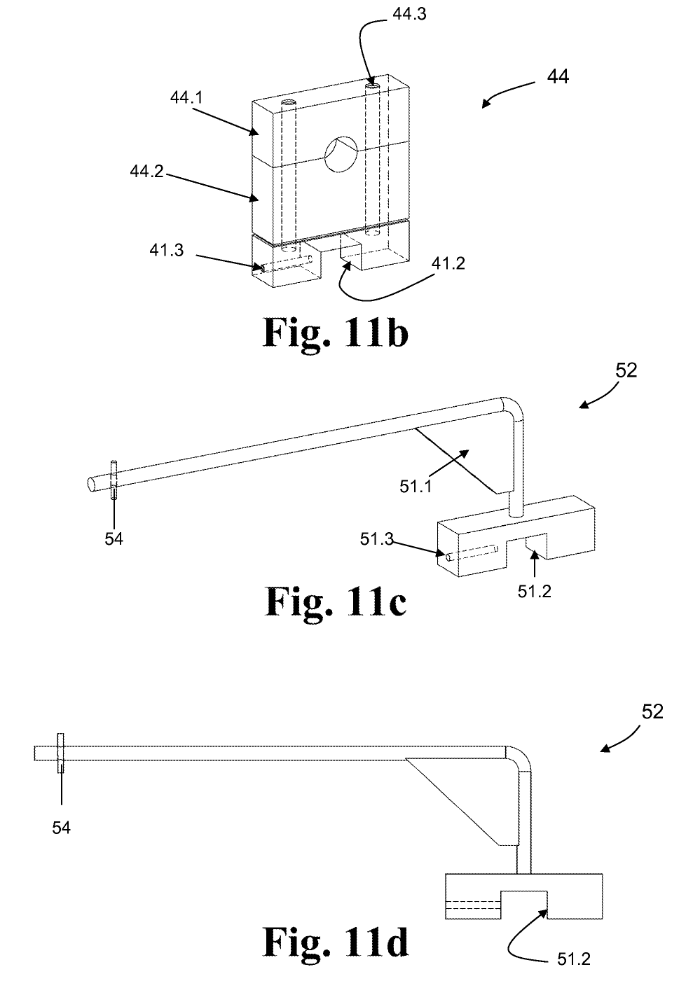

A rotordynamic test rig can be used to test this unbalance correction approach. The test rig 20 is shown in FIGS. 11a, 11b, 11c, and 11d. These figures present a plurality of sketches of a test rig and instrumentation according to one embodiment of the present invention. The rig 20 includes the following features: output to oscilloscope or FFT analyzer 58; proximity probe driver 56; proximity probe aimed at shaft 54; movable proximity probe support (3 per rig) 52; mounting rail for proximity probes 50; drive motor 40; flexible coupling to drive shaft without transferring lead or moment 42; test shaft 30; and balancing holes 32 preferably—six equally spaced around shaft circumference at three locations (O, P, and Q)—with various set screws for making the balance changes or for attaching the balance changes.

Rig 20 further includes movable bearing supports (3 per rig) 44 as shown in FIG. 11b, each having a loose fit bearing slip onto shaft 30 and also having the following features: bolts 44.3 to clamp bearing housing halves 44.1 and 44.2 together; allowability to add shims and misalignment; groove 41.2 for sliding on rail 41; long set screw 41.3 to secure support 44 to rail 41; and mounting rail 41 for bearing supports 41.

FIGS. 11c and 11d shows side view and perspective sketched views of instrumentation for the test rig according to another embodiment of the present invention. This probe support includes the following features: gusset 51.1 to prevent motion of arm 51; electrical leads; groove 51.2 for sliding on rail 50; long set screw 51.3 to prevent support 51 from moving; and Bentley-Nevada type proximity probe 54, which threads through arm for easy adjustment/replacement.

While the inventions have been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method for balancing a shaft, comprising:
providing a cylindrical shaft having centerline, a length between first and second ends, and three planes (G, H, and I) each intersecting the centerline and sequentially spaced apart from the first end to the second end, the shaft having a critical speed;
supporting the shaft at the first end and at the second end;
rotating the supported shaft at a speed less than the critical rotational speed;
measuring during said rotating at the first end a first unbalance weight acting at a first phase angle;
measuring during said rotating at the second end a second unbalance weight acting at a second phase angle;
applying within plane H a first correction weight that is less than the sum of the first unbalance weight and the second unbalance weight;
applying the first correction weight at a first corrected phase angle that is between the first phase angle and the second phase angle;
applying within plane G a second correction weight that is less than the first unbalance weight;
applying the second correction weight at a second corrected phase angle that is between the first phase angle and the first corrected phase angle;
applying within plane I a third correction weight that is less than the second unbalance weight; and
applying the third correction weight at a third corrected phase angle that is between the second phase angle and the first corrected phase angle.

2. The method of claim 1 which further comprises after said applying the third correction weight, said applying the second correction weight, and said applying the first correction weight:
rotating the shaft at a speed less than the critical rotational speed;
measuring during said rotating at the first end a third unbalance weight acting at a third phase angle;
measuring during said rotating at the second end a fourth unbalance weight acting at a fourth phase angle;
applying at the first end a fourth correction weight substantially the same as the third unbalance weight; and
applying at the second end a fifth correction weight substantially the same as the fourth unbalance weight.

3. The method of claim 1 wherein the critical speed corresponds to the first bending mode.

4. The method of claim 3 wherein the three planes (G, H, and I) are equally spaced apart.

5. The method of claim 1 wherein the first corrected phase angle is midway between the first phase angle and the second phase angle, the second corrected phase angle is midway between the first phase angle and the first corrected phase angle, and the third corrected phase angle is midway between the second phase angle and the first corrected phase angle.

6. The method of claim 1 wherein the first correction weight is less than half of the sum of the first unbalance weight and the second unbalance weight.

7. The method of claim 6 wherein the second correction weight is about one half the first unbalance weight.

8. The method of claim 7 wherein the third correction weight is about one half of the second unbalance weight.

9. A method for balancing a shaft, comprising:
providing a cylindrical shaft having centerline, a length between first and second ends, and three positions (G, H, and I) sequentially spaced apart from the first end to the second ends, the shaft having a critical speed;
supporting the shaft at the first end and at the second end;
rotating the shaft at a speed less than the critical rotational speed;
measuring during said rotating at the first end a first unbalance weight acting at a first phase angle;
measuring during said rotating at the second end a second unbalance weight acting at a second phase angle;
applying within position H a first correction weight that is less than one half of the sum of the first unbalance weight and the second unbalance weight;
applying the first correction weight at a first corrected phase angle that is between the first phase angle and the second phase angle;
applying within position G a second correction weight that is about one half of the first unbalance weight;
applying within position I a third correction weight that is about one half of the second unbalance weight;
rotating the corrected shaft having the first correction weight, second correction weight, and third correction weight at a speed less than the critical rotational speed;
measuring during said rotating the corrected shaft a third unbalance weight at the first end;
measuring during said rotating the corrected shaft a fourth unbalance weight at the second end;
applying at the first end a fourth correction weight substantially the same as the third unbalance weight; and
applying at the second end a fifth correction weight substantially the same as the fourth unbalance weight.

10. The method of claim 9 wherein said applying the second correction weight is at a second corrected phase angle that is between the first phase angle and the first corrected phase angle.

11. The method of claim 10 wherein said applying the third correction weight is at a third corrected phase angle that is between the second phase angle and the first corrected phase angle.

12. The method of claim 9 wherein the critical speed corresponds to the first bending mode.

13. The method of claim 9 wherein the three positions (G, H, and I) are equally spaced apart.

14. The method of claim 9 wherein the shaft is a shaft for a gas turbine engine.
